(19) United States
(12) Patent Application Publication
(10) Pub. No.: US 2021/0341131 A1
(43) Pub. Date: Nov. 4, 2021

(54) HEAT DISSIPATING CARBON FIBER LIGHT FIXTURE

(71) Applicant: PLASHLIGHTS LLC, Dickinson, TX (US)

(72) Inventors: Stephen Monroe Plash, IV, Dickinson, TX (US); Geoffrey William Germon, Freshwater (AU)

(21) Appl. No.: 17/239,835

(22) Filed: Apr. 26, 2021

Related U.S. Application Data
(60) Provisional application No. 63/017,701, filed on Apr. 30, 2020.

(51) Int. Cl. F21V 15/01; F21V 17/10; F21V 29/70; F21V 7/00

(52) U.S. Cl. CPC F21V 15/01; F21V 17/101; F21Y 2115/10; F21V 7/005; F21V 29/70

(57) ABSTRACT

Electrical lighting housings and heat sinks constructed of pitch-based carbon fiber that act as heat sinks for light emitting diode (“LED”/“LEDs”) lights. Greater heat dissipation cools the LED lights and power suppling components, which in turns increases the life span of these components, without the need for active cooling. Due to the improved physical strength of pitch-based carbon fiber over aluminum and other typical heat sink and housing materials, the wall thickness of a housing can be decreased when using pitch-based carbon fiber which can further aid in thermal transfer.

### CROSS-REFERENCE TO RELATED APPLICATIONS

This application is based on and claims priority to U.S. Provisional Patent Application No. 63/017,701 filed Apr. 30, 2020 entitled “HEAT DISSIPATING CARBON FIBER LIGHT FIXTURE”

### SUMMARY OF THE INVENTION

The present invention relates to improvements to electrical lighting housings and heat sinks, particularly to housings constructed of pitch-based carbon fiber that act as heat sinks for light emitting diode (“LED”/“LEDs”) lights. For purposes of this disclosure pitch-based carbon fiber can also include graphite, either being added to the material prior to curing or is synthesized during the curing process from non-graphite carbon. While the below description describes the invention being used with LEDs, the present invention can be adapted by those skilled in art for other lighting and electrical applications where improved heat dissipation, Chemical resistance, structural strength, and/or low mass are desirable and/or advantageous. It is envisioned that the present invention can be adapted for use with future light sources, including laser light sources.

The present invention has several advantages over prior art products. Current housings for LED lights are most commonly made from aluminum which does not dissipate the heat produced by LED lights as well as pitch-based carbon fiber. In other words pitch-based carbon fiber has a higher thermal conductivity than aluminum and even copper. Greater heat dissipation cools the LED light and power suppling components, which in turns increases the life span of these components, without the need for active cooling. Due to the improved physical strength of pitch-based carbon fiber over aluminum and other typical heat sink and housing materials, the wall thickness of a housing can be decreased when using pitch-based carbon fiber which can further aid in thermal transfer.

In addition to the above advantages, pitch carbon light housings do not corrode when exposed to harsh environments such as brackish and saltwater environments. Furthermore, the housing of the present invention can also be attached via bonding in preference to using mechanical fasteners, which is not a viable solution. when using aluminum. The above benefits are particularly important in outdoor and marine environments. Yet another advantage is the housings of the present invention made from pitch-based carbon are of lower mass than if made from other more typical materials.

In one embodiment the invention is a light fixture including a housing adapted to receive a printed circuit board having at least one light emitting diode; the printed circuit board being in contact with the housing; and where at least a portion of the housing in contact with the printed circuit board is constructed of pitch-based carbon fiber. In another embodiment the housing is sealed via bonding. In yet another embodiment is also includes a reflector configured to direct light produced by the at least one light emitting diode in a predetermined direction. In still another embodiment the light fixture includes a transparent lens bonded to the housing. In yet still another embodiment the printed circuit board is configured to conduct electricity from a power source to the at least one light emitting diode. In but another embodiment the light fixture further includes a reflector configured to direct light produced by the at least one light emitting diode in a predetermined direction, a transparent lens bonded to the housing configured to allow light produced by the at least one light emitting diode to pass in the predetermined direction, and where the printed circuit board is configured to conduct electricity from a power source to the at least one light emitting diode.

In another embodiment the present invention is a method of manufacturing a light emitting diode light fixture including the steps of fabricating a pitch based carbon fiber impregnated with a resin putty; then compressing and heating the pitch based carbon fiber impregnated with the resin putty to a predetermined pressure and a predetermined temperature until the pitch based carbon fiber impregnated with the resin putty has cured, creating a pitch-based carbon fiber part; deflashing and cleaning the pitch-based carbon fiber part; and attaching a printed circuit board having at least one light emitting diode to the pitch-based carbon fiber part. In yet another embodiment adds the step of bonding a transparent lens to the pitch-based carbon fiber part. In but another embodiment adds the step of coupling the printed circuit board to a reflector configured to direct light produced by the at least one light emitting diode in a predetermined direction. In but still another embodiment the method further includes the steps of: coupling the printed circuit board to a reflector configured to direct light produced by the at least one light emitting diode in a predetermined direction, and bonding a transparent lens to the pitch-based carbon fiber part, where the transparent lens bonded to the housing is configured to allow light produced by the at least one light emitting diode to pass in the predetermined direction.

### BRIEF DESCRIPTION OF THE DRAWINGS

FIG. 1 is an isometric exploded view of an embodiment of the LED light fixture;

FIG. 2 is aside view of the embodiment of the LED light fixture (shown in FIG. 1);

FIG. 3 is a front view of the embodiment of the LED light fixture (shown in FIG. 1);

FIG. 4 is a cross sectional view along line A-A (shown in FIG. 3) of the embodiment of the LED light fixture; and

FIG. 5 is a flow chart of a method making the embodiment of the LED light fixture (shown in FIG. 1);

### DETAILED DESCRIPTION OF THE INVENTION

Prior to proceeding with the more detailed description of the present invention it should be noted that, for the sake of clarity, identical components which have identical functions have been designated by identical reference numerals throughout the several views illustrated in the drawings.

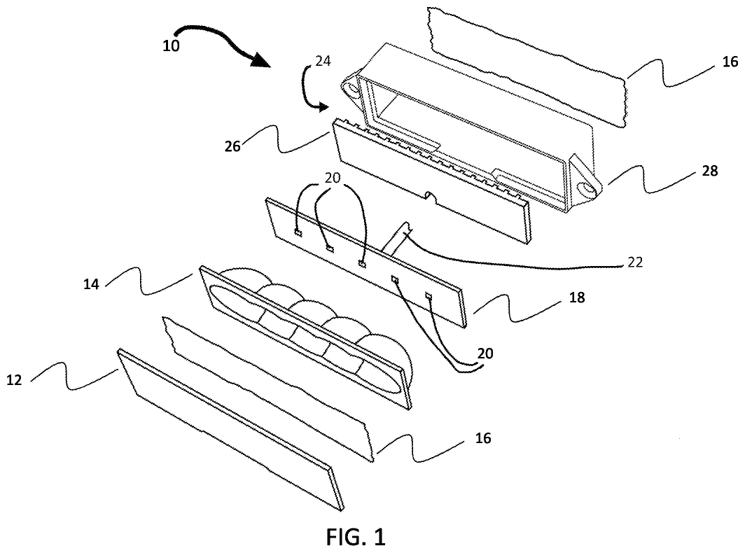

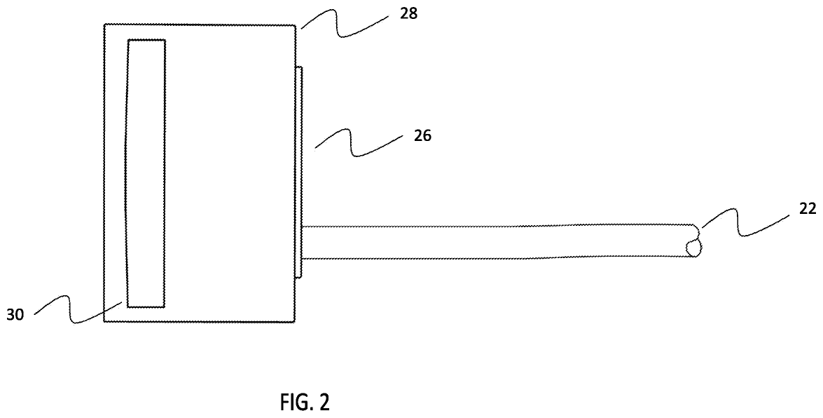

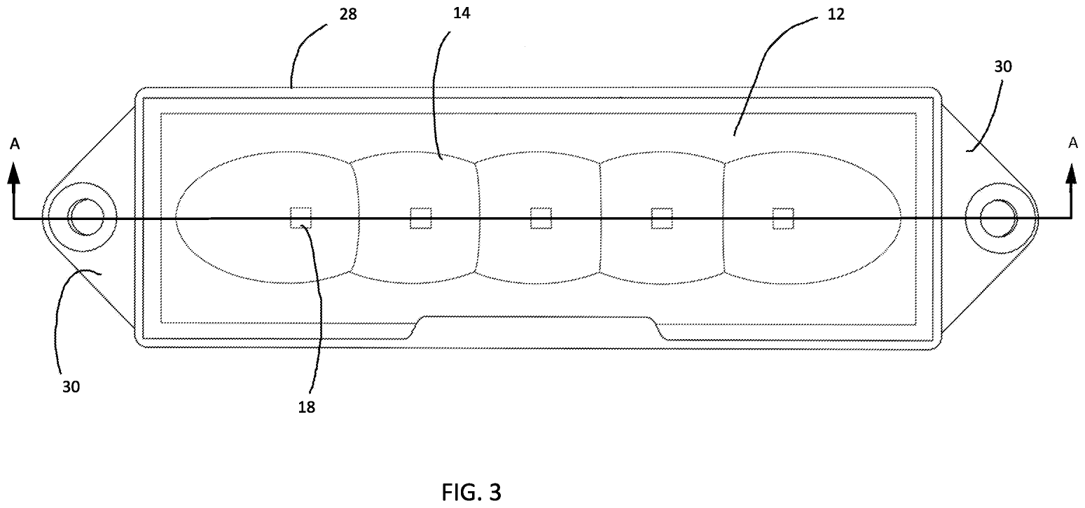

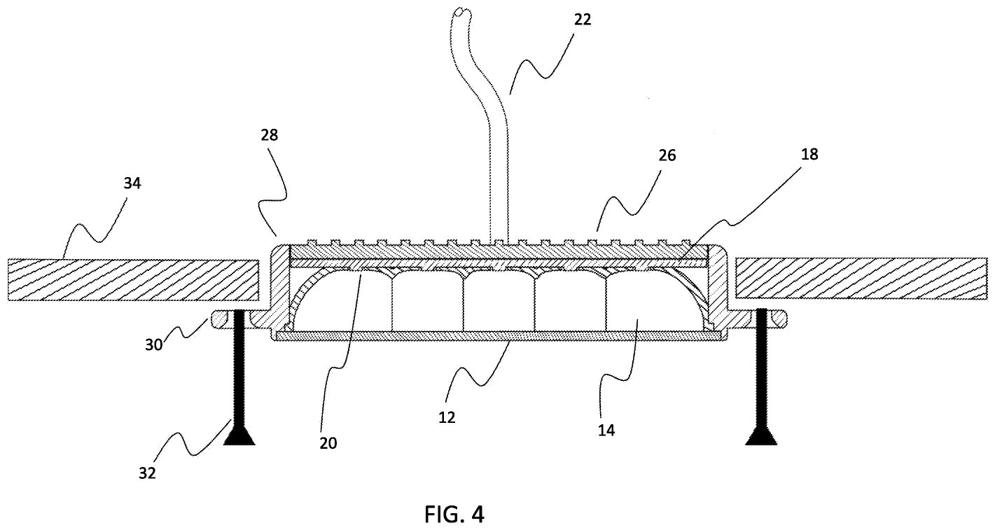

Referring in particular to FIGS. 1-4, in a first aspect the present invention provides an apparatus, generally designated 10, including a transparent lens 12 bonded to a reflector 14 via epoxy 16. The apparatus 10 further includes a printed circuit board 18 with LEDs 20 disposed thereon. The printed circuit board 18 is connected to a power supply (not shown) via power cable 22. Pitch carbon fiber housing, generally designated 24, comprises first element 26 and second element 28. First element 26 and second element 28 may be constructed as two parts that are bonded together, or as a single uniform part. The pitch carbon fiber housing 24 is attached and in direct contact with at least a portion of the printed circuit board 18 once the apparatus 10 is fully assembled. Integrated mounting shoulders 30 are configured to receive mounting bolts 32 for attachment to bulkhead 34 or the like. The apparatus 10 may also be mounted via epoxy 16 to any suitable surface. Adhesive, tape, or the like could be used in place of epoxy 16 above.

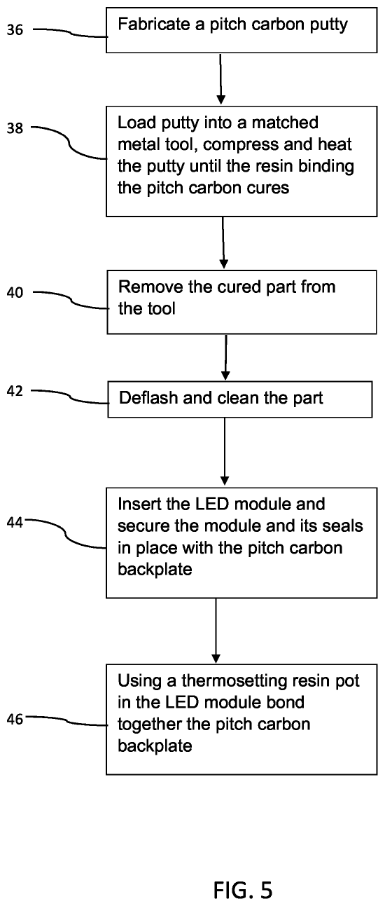

Referring to FIG. 5, an illustrative example of a method of producing a LED assembly of the present invention includes the following steps:
Fabricate a pitch carbon putty 36;
Load putty into a matched metal tool, compress and heat the putty until the resin binding the pitch carbon cures 38; (As the carbonization temperature is increased, the concentration of point defects is reduced and the crystalline perfection increases, thereby resulting in an improved thermal conductivity. A high fiber fraction and a low void content is preferred);
Remove the cured part from the tool 40;
Deflash and clean up the part 42;
Insert the LED module and secure the module and its seals in place with the pitch carbon backplate 44 (which keeps the PCB board and attached LED's at a lower temperature); and
Using a thermosetting resin pot in the LED module to bond in the pitch carbon backplate 46 (This seals the entire housing against dust and water).

While presently preferred embodiments of the present invention has been described in detail above, it should be understood that various other adaptations and/or modifications of the invention can be made by those persons who are particularly skilled in the art without departing from either the spirit of the invention or the scope of the appended claims.

What is claimed is:

1. A light fixture comprising:
a housing adapted to receive a printed circuit board having at least one light emitting diode;
the printed circuit board being in contact with the housing; and
wherein at least a portion of the housing in contact with the printed circuit board is constructed of pitch-based carbon fiber.

2. The light fixture of claim 1, wherein the housing is sealed via bonding.

3. The light fixture of claim 1, further comprising a reflector configured to direct light produced by the at least one light emitting diode in a predetermined direction.

4. The light fixture of claim 1, further comprising a transparent lens bonded to the housing.

5. The light fixture of claim 1, wherein the printed circuit board is configured to conduct electricity from a power source to the at least one light emitting diode.

6. The light fixture of claim 1, further comprising a reflector configured to direct light produced by the at least one light emitting diode in a predetermined direction,
a transparent lens bonded to the housing configured to allow light produced by the at least one light emitting diode to pass in the predetermined direction, and
wherein the printed circuit board is configured to conduct electricity from a power source to the at least one light emitting diode.

7. A method of manufacturing a light emitting diode light fixture comprising the steps of:
fabricating a pitch based carbon fiber impregnated with a resin putty;
compressing and heating the pitch based carbon fiber impregnated with the resin putty to a predetermined pressure and a predetermined temperature until the pitch based carbon fiber impregnated with the resin putty has cured, creating a pitch-based carbon fiber part;
deflashing and cleaning the pitch-based carbon fiber part; and
attaching a printed circuit board having at least one light emitting diode to the pitch-based carbon fiber part.

8. The method of claim 7, further comprising the step of bonding a transparent lens to the pitch-based carbon fiber part.

9. The method of claim 7, further comprising the step of coupling the printed circuit board to a reflector configured to direct light produced by the at least one light emitting diode in a predetermined direction.

10. The method of claim 7, further comprising the steps of:
coupling the printed circuit board to a reflector configured to direct light produced by the at least one light emitting diode in a predetermined direction, and
bonding a transparent lens to the pitch-based carbon fiber part,
wherein the transparent lens bonded to the housing is configured to allow light produced by the at least one light emitting diode to pass in the predetermined direction.
